(19) United States
(12) Patent Application Publication
(10) Pub. No.: US 2005/0099108 A1
(43) Pub. Date: May 12, 2005

(54) Lamp

(76) Inventors: Harald Hofmann, Ludenscheid (DE); Achim Hilscher, Friedberg Statzling (DE); Thomas Noll, Kipfenberg (DE); Martin Zachau, Geltendof (DE)

Correspondence Address: Thomas Langer;Cohen Pontani Lieberman & Pavane, Suite 1210, 551 Fifth Avenue, New York, NY, 10176, US

(21) Appl. No.: 10/500,825

(22) PCT Filed: Jan. 3, 2003
(86) PCT No.: PCT/DE03/00008

(30) Foreign Application Priority Data
Jan. 10, 2002 (DE) 102 00 778.0

(51) Int. Cl. H01J 5/00; H01J 5/48; H01J 5/50

(52) U.S. Cl. 313/317; 313/318.01; 313/318.12

(57) ABSTRACT

A lamp (10, 10′) which comprises at least one base (11, 11′) for connection to a lamp socket on the lamp and at least one LED element (12). The lamp is provided with a plurality of LED elements (12) that are disposed at a distance to the socket and combined to a constructional unit (13, 13′).

### TECHNICAL FIELD

The invention relates to a lamp, which comprises at least one base for connection to a luminaire-side lamp fitting and at least one LED element (light-emitting diode).

### PRIOR ART

Such a lamp is described in DE 198 29 270 A1. In this document, at least two lamp elements having a different color temperature are provided, it being possible to vary the overall color temperature of the lamp. One of the two lamp elements is in this case in the form of an LED element.

When arranging LED elements in a lamp, account must be taken of the fact that LED elements generally emit directed light. In order to achieve a homogeneous luminance distribution of the LED light emitted by the lamp or, in the case of two lamp elements, of the light emitted by the lamp which has an LED light component a particular arrangement of the LED elements is required.

### SUMMARY OF THE INVENTION

The invention is based on the object of developing the known lamp such that the lamp allows for homogeneous luminance distribution of the LED light emitted by the LED element using a simple design for the lamp.

This object is achieved according to the invention by two or more LED elements being provided which are arranged spaced apart from the base and are combined to form one module.

The principle of the invention thus essentially consists in the LED elements not being arranged in the base of the lamp and the LED light, which would be generated close to the base or in the base, being distributed in the volume of the lamp by means of light-conducting elements or light-deflecting elements, but by the LED elements being arranged such that they are spaced apart from the base, making it possible for the LED light emitted by the two or more LED elements to be made uniform to a certain extent within the lamp volume. Naturally, light-deflecting elements or light-conducting elements can be provided which further improve the uniformity of the luminance distribution, it being possible, for example, for diffuser elements to be provided. The distributed arrangement of the LED elements according to the invention at least in one subregion of the lamp volume may, however, significantly improve the uniformity of the luminance distribution of the LED light of the lamp.

The solution according to the invention also offers the possibility of the lamp having a particularly simple structural design. For example, the module may be prefabricated in the form of a separate element, which is to be fixed to the base of the lamp, and then mounted on the base. In addition, there is in principle the possibility of using known modules, which may result in inexpensive lamps according to the invention. Combining two or more LED elements to form one module makes it possible to produce the lamp according to the invention in a particularly simple manner in this regard.

In addition, it is possible in this manner to largely rule out the situation in which the regions where the individual LED elements are connected to the component are influenced in terms of temperature by heat which is generated in the region where any further lamp elements provided are connected to the lamp. In particular in the case of a lamp in which different lamp elements are provided, it is in this manner possible to arrange only the lamp element of the second type directly on the base of the lamp and to arrange the LED elements on the module and thus only indirectly on the base. There is thus provided a larger surface, namely the surface of the module, for heat dissipation of the heat generated by the LED elements, and this surface would not be present if the LED elements were arranged within the base of the lamp. The surface of the module is furthermore separated from the surface of the base of the lamp.

The lamp according to the invention may have a base at one or two ends. The lamp may be, for example, a lamp having a conventional drop-shaped basic shape having a screw base, the module having LED elements being arranged within the lamp volume. Alternatively, the lamp according to the invention may also be in the form of a lamp having a base at one end and having plug connections in the manner of a conventional compact fluorescent lamp. Finally, lamp shapes also come into consideration which have a base at two ends in the manner of conventional fluorescent lamps.

In the sense of the present patent application, the term LED light is understood to mean the radiation emitted by the LED elements which is preferably in the visible wavelength range. In principle, however, it is also conceivable, and also included in the meaning of the term LED light in the sense of the present invention, to use LED elements which emit radiation in other, non-visible wavelength ranges, for example in the short-wave UV range. When using such LED elements, an additional bulb element which envelops a lamp volume, for example, may be used which is provided on its inner side with a fluorescent layer which converts the short-wave LED UV light into visible light.

The LED elements of the lamp according to the invention may be monochromatic or have different colors. Colored operation may thus also be achieved, for example, using suitable control means.

The arrangement according to the invention of two or more LED elements on one module also makes possible, in addition to particularly simple driving, a particularly simple arrangement of connection and control lines. In particular, the design for the base of the lamp may be particularly simple. It is possible to connect the module to the lamp base using a plug connection.

According to an advantageous refinement of the invention, two or more LED elements are at least partially combined to form an essentially row-like arrangement. This design makes it possible, for example, to arrange the module essentially along a longitudinal axis of the lamp, resulting by simple means in maximum uniformity of the luminance distribution of the LED light within the lamp volume. In addition, recourse may be made to known modules.

According to a further advantageous refinement of the invention, the LED elements are combined to form a linear arrangement. This design makes it possible in a particularly simple manner to use known components in order to be able to keep development and production costs low. For example, linear arrangements of LED elements, which are let into acrylic glass (plexiglass), are known from other fields. Such modules, with or without modifications, may be used for arrangement in a lamp. Furthermore, combining the LED elements to form a linear arrangement results in an arrangement of the LED elements which is uniformly distributed in the lamp volume and thus in a uniform luminance distribution.

According to a further refinement of the invention, the linear arrangement is aligned essentially along the longitudinal axis of the lamp. In particular in the case of lamps which are elongate, i.e. which have a bulb-shaped lamp volume, for example, this arrangement makes a particularly uniform luminance distribution possible. In this case, the linear arrangement with the LED elements is arranged essentially perpendicular to a plane which is formed by the cross-sectional surface (width) of the base. In particular, this makes particularly simple assembly possible when the linear arrangement is arranged in a particularly stable manner on the base.

According to an advantageous refinement of the invention, the module is essentially light-permeable. This refinement makes possible homogeneous light intermixing.

According to a further alternative refinement of the invention, the module is designed to be essentially reflective or light-scattering. An essential advantage of this refinement is the fact that multiple reflections can take place on the surface of the module. In this case, a geometric arrangement of the module or the LED elements and, if necessary, further optionally provided lamp elements can be provided which likewise makes possible homogeneous light intermixing. In particular, the module may be arranged such that it is directly adjacent to a lamp element of the second type, making it possible for a high degree of multiple reflection to take place between the module and the material regions of the lamp element.

According to a further advantageous refinement of the invention, a bulb element is provided which at least partially envelops the module. Suitable bulb elements are, for example, a light-permeable glass or plastic cylinder. In principle, it is possible for the bulb element to be in the form of a protective bulb, for example for a specific pressure to be generated within a lamp volume or for a specific gas filling to be retained. Finally, it is, however, also possible for the bulb element to be provided with openings, for example for the passage of cooling flows of air.

According to an advantageous refinement of the invention, the bulb element is in the form of a diffuser. The diffuser element in this case provides further homogenization of the luminance distribution of the lamp. In the case of two or more LED elements having a different color, the diffuser element may also serve the purpose of intermixing the colors. Finally, when a lamp element of the second type is provided, the diffuser element also contributes to the intermixing of the LED light and of the light emitted by the lamp element of the second type.

According to an advantageous refinement of the invention, the bulb element is made of plastic. This refinement offers the possibility of being able to introduce diffusers into a plastic granulate composition, from which the bulb element is produced. The bulb element which is particularly manufactured in the form of a plastic injection-molded part may in this manner be provided with particularly homogeneously distributed diffusers. The production complexity is in this case low. The diffusers may either be admixed to the plastic granulate or be an integral part of the granulate.

The diffusers may also be made of fluorescent material.

According to a further advantageous refinement of the invention, at least one lamp element of the second type is arranged on the base. This may be, for example, a compact fluorescent lamp or else a high-pressure discharge lamp or the like. In particular, when the lamp element of the second type and the LED elements arranged in the module have different color temperatures, provision may be made for the overall color temperature of the lamp to be varied, as is described in DE 198 29 270 A1. For this purpose, it is possible for the LED elements of the module, possibly also individually, and/or the lamp element of the second type to be designed such that they can be dimmed and/or switched on or off.

In this manner, it is also possible, for example, to construct a lamp which provides an efficient emergency or continuous light which is generated by the LED elements, and in which, where necessary, the lamp element of the second type is connected for the purpose of generating a high luminous flux.

According to the invention, a lamp is made possible which allows for a luminance distribution of the light emitted by the LED elements which is similar to an at least very considerable extent to the luminance distribution of the light emitted by the lamp element of the second type.

According to a particularly advantageous refinement of the invention, provision is made for the LED elements of red LEDs to be provided and for them to be combined with a lamp element of the second type in the form of an Hg fluorescent lamp. This makes it possible for white light with color temperatures of less than 2500 K to be produced as is generated when dimming an incandescent lamp.

The Hg fluorescent lamp, of which two or more may also be provided, may have any desired shape and may be in the form of, for example, a compact lamp or a linear lamp. Suitable here are compact fluorescent lamps, for example, having discharge vessels which have at least one piece which is bent in particular in the form of a U, in particular DULUX-T/E compact fluorescent lamps, DULUX-S/E or DULUX L lamps by OSRAM.

According to a further advantageous refinement of the invention, the bulb element at least partially envelops both the module having the LED elements and the lamp element of the second type. In this manner, a compact lamp is made possible which has a common bulb element which is, for example, in the form of a diffuser and serves the purpose of intermixing the light generated by the two lamp elements. In addition, a lamp according to the invention may thus be constructed which is at least considerably similar in its physical shape to conventional lamps.

According to a further advantageous refinement of the invention, the module is essentially light-permeable. Suitable materials are, for example, those such as acrylic glass or another, light-permeable plastic. Apart from the LED elements themselves, which can be, for example, let into the module, and apart from their control lines, which may have, however, only a very small diameter, the module may thus be permeable to the light emitted by the LED elements as well as to the light emitted by an optionally provided lamp element of the second type. This design means that problems associated with shadowing are almost completely avoided. In addition, almost any desired arrangement of the module within the lamp volume can thus be carried out without there being any problems associated with shadowing.

According to a further advantageous refinement of the invention, the lamp is essentially symmetrical with respect to a central plane of the lamp. For example, this may come about by a central arrangement of the module on the base and a correspondingly symmetrical formation of the lamp elements of the second type. Finally, however, it is also conceivable for at least two modules to be arranged symmetrically along a central plane of the lamp. Alternatively, the module may also comprise two sections, the sections being arranged symmetrically with respect to the central plane of the lamp.

In particular owing to the arrangement of at least two modules spaced apart from one another, symmetrically with respect to the central plane or owing to the arrangement of at least two sections of a module spaced apart from one another and symmetrically with respect to the central plane, it is possible, on the one hand, to achieve a symmetrical, preferably also directed light distribution of the LED light. On the other hand, the spacing also makes it possible to effectively dissipate the heat generated by the LED elements.

According to a further advantageous refinement of the invention, the LED elements are each arranged on one side of the module. In particular for the case in which the module has an at least partially curved surface and is light-permeable, it is thus possible for the module to provide a lens, in particular a cylindrical lens, which focuses the LED light. The luminous flux may thus be deflected in a preferred direction. It is thus possible to almost completely prevent problems associated with shadowing.

### BRIEF DESCRIPTION OF THE DRAWINGS

Further advantages of the invention are described in the description below of two exemplary embodiments illustrated in the drawings, in which:

FIG. 1 shows a schematic, partially sectioned side view of a first exemplary embodiment of the lamp according to the invention having a base at one end,

FIGS. 1a to 1c show schematic illustrations of a partially sectioned view, for example along the section line X-X in FIG. 1, of three different designs for the lamp shown in FIG. 1,

FIG. 2 shows a schematic, partially sectioned, broken-away view of a second exemplary embodiment of a lamp according to the invention which has a base at two ends,

FIGS. 2a and 2b show a schematic illustration of a partially sectioned view, for example along the section line Y-Y in FIG. 2, of two different refinements of the lamp shown in FIG. 2, FIG. 2b having two modules and a lamp element of the second type,

FIG. 3 shows a schematic side view of a third exemplary embodiment of a lamp having a base at one end, and

FIG. 4 shows a schematic of the exemplary embodiment shown in FIG. 3, for example according to viewing arrow IV in FIG. 3.

### PREFERRED EMBODIMENTS OF THE INVENTION

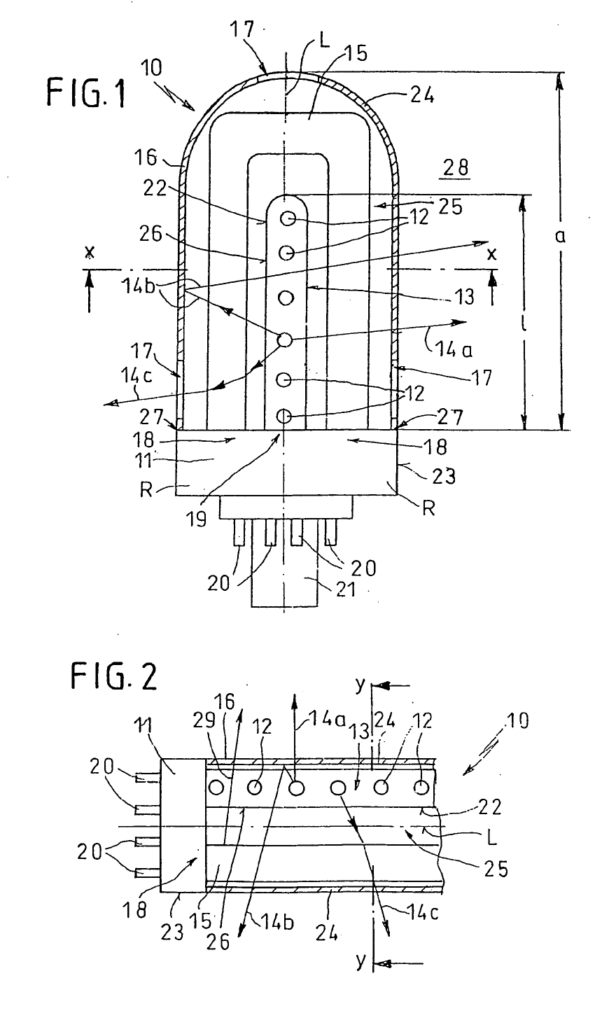

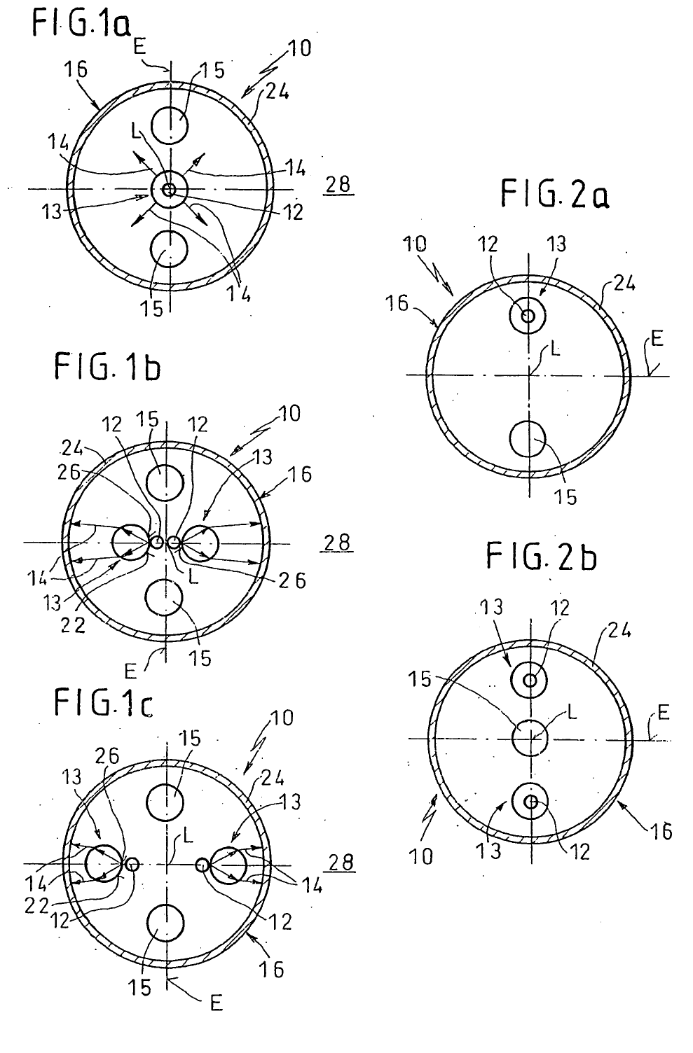

FIG. 1 shows a lamp which is given the overall designation 10 and has a base 11. The base 11 has associated electrical connections 20 and a mechanical connection 21 for connection to a luminaire-side lamp fitting (not shown).

A module 13, which has two or more, in the case of the exemplary embodiment shown in FIG. 1 six, different LED elements 12, is arranged on the base 11. The LED elements 12 are arranged linearly in a row, with the result that the module 13 is overall linear and extends along the longitudinal axis L of the lamp 10. The module 13 is arranged centrally on the base 11.

For example, the six LED elements 12 may be incorporated in a module 13 made of acrylic glass. However, it is also possible for the LED elements 12 to be arranged on one side 26 of the module 13.

According to FIG. 1, an essentially U-shaped lamp element 15 of the second type engages around the linear module 13. The lamp element 15 of the second type may, for example, be in the form of a compact fluorescent lamp.

The lamp element 15 of the second type and the module 13 have special connection regions 18 and 19, respectively, to the base 11. The lamp element 15 of the second type and the module 13 are driven separately by means of connection lines (not shown in any more detail) which run at least partially through the base 11. Provision may also be made for individual LED elements 12 to be driven independently of one another, which, if necessary, includes a dimming operation.

The lamp volume 25 is defined as the interior of a bulb element 24 which envelops the component 13 and the lamp element 15 of the second type. The bulb element 24 is connected separately by means of the connection region 27 to the base 11.

The bulb element 24 may be, for example, a completely enclosed glass bulb which makes it possible to allow a pressure to prevail in the lamp volume 25 which is different than the pressure in the exterior 28 of the lamp 10 or to arrange a gas in the lamp volume 25.

The base 11 and the bulb element 24 are circular-cylindrical in cross section.

In the case of the exemplary embodiment shown in FIG. 1, the bulb element 24 is in the form of a diffuser 16, which has the function, inter alia, of mixing the light which is emitted by the lamp element 15 of the second type and by the LED elements 12, so as to achieve a homogeneous luminance distribution of the lamp 10 for a viewer.

In the exemplary embodiment shown in FIG. 1, two openings 17, which are in the form of air passage openings and can serve the purpose of passing a flow of heat-dissipating air through, are arranged in the diffuser element 16.

The path of the light 14 emitted by the LED elements 12 will be explained schematically with reference to arrows 14a, 14b and 14c:

Some of the light emitted by the LED elements 12 leaves the lamp 10 directly, for example along the schematic optical path 14a. A further light component is scattered or reflected at the diffuser element 16 as shown by the arrow path 14b and leaves the lamp 10 only after it has been reflected one or more times. A third light component may, for example, also be subjected to light deflection by means of the lamp element 15 of the second type, as is shown, for example, by the arrow path 14c. Finally, combinations of the arrow paths 14b and 14c are also possible. The same applies to the light emitted by the lamp element 15 of the second type. Particularly important in this context is the material of the component 13:

In particular if the LED elements 12 are incorporated in a component 13 which is made of a light-permeable material, such as acrylic glass, for example, it is possible to virtually prevent problems associated with shadowing. The component 13 is in this case permeable both to the LED light 14 and to the light emitted by the lamp element 15 of the second type, of course with the connecting lines (not shown) for the LED elements 12, which extend within the module 13, being removed.

Finally, the module 13 may also take on the function of a diffuser, which additionally intermixes the light emitted by the LED elements 12 and the light emitted by the lamp element 15 of the second type.

The connection region 19 of the module 13 is arranged approximately centrally on the base 11. The connection region 18, which is essentially in the form of a circular ring, of the lamp element 15 of the second type is arranged comparatively close to the edge R of the base 11, as compared with FIG. 1. The heat which is generated in the connection region 18 can have only a limited effect on the LED elements 12 owing to the large spacing between the LED elements 12 and the connection region 18. In this manner, parallel operation of the LED elements 12 and the lamp element 15 of the second type is possible. Heat dissipation of the heat generated by the LED elements 12 takes place in particular over the surface 22 of the module 13 in the region 26 where the individual LED elements 12 are connected. A comparatively large surface 22 is thus available which is arranged separately from the surface 23 of the base 11.

In the exemplary embodiment shown in FIG. 1, the linear module 13 is arranged along the longitudinal axis L of the lamp 10 and has a length l which is approximately two thirds of the length a of the bulb element 24. In principle, it is possible with the lamp according to the invention to select the length l of the linear module 13 such that it corresponds to the length a of the bulb element 24.

FIGS. 1a to 1c show, by way of example, three different arrangements of modules 13 and lamp elements 15:

In the exemplary embodiment shown in FIG. 1a, a module 13 is provided with LED elements 12. The two sections of the lamp element 15 are arranged, together with the module 13, along a straight line or along the central plane E. This is a particularly simple formation, it being possible for the light distribution of the LED light 14 of the module 13, as is illustrated by the arrows 14, to overall be symmetrical with respect to the longitudinal axis L of the lamp 10.

FIG. 1b shows an alternative arrangement of two modules 13. These are in turn arranged approximately centrally between the two sections of the lamp element 15. Each module 13 has a number of LED elements 12, for example in each case six LED elements 12. The LED elements 12 are each arranged on the side 26 of the module 13, i.e. in each case on the fixing side, such that a region, which is associated with the fixing side 26, of the surface 22 of the module 13 is in each case available for sufficient heat dissipation.

One advantage here is the fact that, for example, when the module 13 is clear, for example by using acrylic glass, the component 13 itself forms a cylindrical lens. The optical path is illustrated schematically by the arrows 14. Alternatively, the module 13 may be matt and act as a diffuser, for example.

The refinement shown in FIG. 1b shows a lamp 10 having a directed light distribution. The luminance distribution, however, is now in particular symmetrical, to be precise symmetrical both with respect to the longitudinal axis L (axial symmetry) and mirror-symmetrically with respect to a central plane E of the lamp 10.

A likewise advantageous refinement is shown in FIG. 1c, in which, in turn, two modules 13 are provided with in each case LED elements 12 arranged on them. The modules 13 are in this case spaced apart from one another, as a result of which heat dissipation is improved further.

A second exemplary embodiment of the invention is shown in FIG. 2 in the form of a lamp 10 which has a base at two ends. FIG. 2 shows only one end region of a lamp 10 according to the invention which has, at its right-hand end which is not shown with respect to FIG. 2, a further, identical base 11.

The lamp volume 25 is surrounded by a hollow-cylindrical bulb element 24 having a circular cross section. The bulb element 24 is fixed to the base and connects the two opposing bases 11.

According to FIG. 2, as in the arrangement shown in FIG. 1, a linear module 13 is arranged within the lamp volume 25 and comprises a plurality of LED elements 12. For clarity, only six LED elements 12 are illustrated which are arranged linearly, i.e. along a straight line. The straight line extends parallel to the longitudinal axis L of the lamp 10.

Parallel to the linear module 13 is arranged a lamp element 15 of the second type which is in the form of a conventional fluorescent lamp.

The light emitted by the LED elements 12 is, as in FIG. 1, illustrated only schematically by the arrow paths 14a, 14b and 14c with respect to its optical path. The bulb element 24, which is also in the form of a diffuser 16 in this exemplary embodiment, on the one hand ensures intermixing of the different light components of the LED light 14 and, on the other hand, also ensures intermixing of the LED light 14 with the light emitted by the lamp element 15 of the second type. Here too, problems associated with shadowing occur only very little owing to the essentially light-permeable formation of the module 13. The light emitted by the lamp element 15 of the second type can, as shown by the arrow path 29, also pass through the module 13, which in turn is made of acrylic glass, only the LED elements 12 themselves and the connecting lines (not shown) for the LED elements 12 having a disruptive effect on the passage of light through the module 13, which is, however, in practice insignificant.

FIGS. 2a and 2b show different refinements of the lamp shown in FIG. 2. FIG. 2a shows an arrangement of a module 13 and of a lamp element 15 as in the illustration shown in FIG. 2. FIG. 2b is intended to illustrate the fact that in the same manner it is also possible for two modules 13 to be provided within the bulb element 24 together with a lamp element 15 which is arranged approximately centrally within the two modules 13. The exemplary embodiment 2b generates, in a particularly advantageous manner and as in the refinements shown in FIG. 1b and FIG. 1c, a symmetrical luminance distribution for the LED light 14. Symmetry is provided, in particular, with respect to the central plane E of the lamp 10. At the same time, symmetry is established with respect to the longitudinal axis L of the lamp 10.

In principle, it is also possible for the inner side of the bulb element 24 or of the diffuser element 16 to be provided with a fluorescent layer (not shown), for example in order to convert short-wave light, which is emitted by the LED elements 12 and is in the UV range, into visible light.

Finally, the module 13 may also, however, be arranged within the protective bulb of a conventional fluorescent lamp.

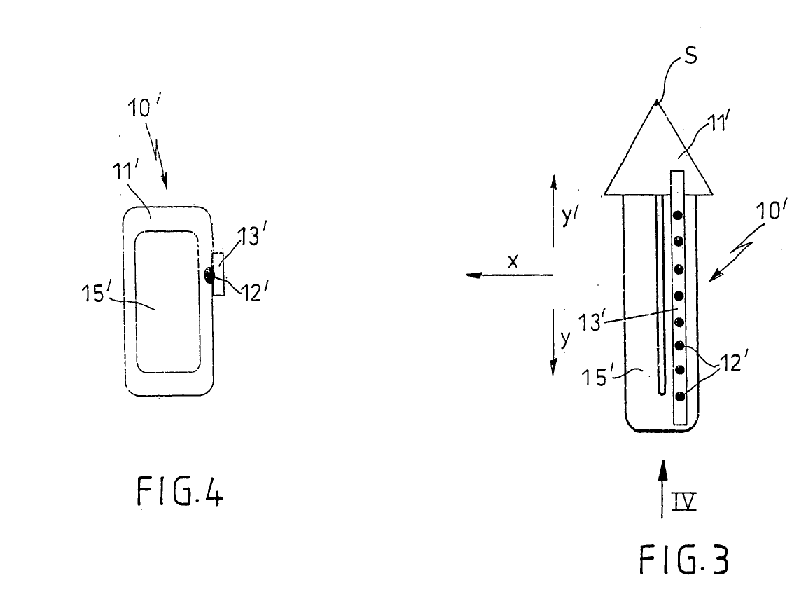

FIG. 3 shows a third exemplary embodiment of the lamp according to the invention, in which an Hg fluorescent lamp 15′ is combined with a module having eight LED elements 12. This lamp element 15′ of the second type, which is commercially available in particular under the designation DULUX S/E or DULUX-L and is in the form of a compact fluorescent lamp, is essentially in the form of a U-shaped dual limb. The module 13′ is fixed, separately from the lamp element 15′ of the second type, to a base 11′ which is essentially triangular in cross section. The lamp element 15′ of the second type and the module 13′ are aligned essentially parallel to one another.

In the exemplary embodiment of FIGS. 3 and 4, a separate bulb element can be dispensed with. The LED light is redistributed and made uniform by means of the fluorescent layer of the lamp element 15′ and by means of multiple reflections on the module 13′. In particular, it is advantageous in this context for the module 13′ in this exemplary embodiment to be essentially light-impermeable, but in any case for it to be reflective.

The particular shape of the base 11′ makes it possible, for example, to arrange two or more identical lamps 10′ in a row such that a linear row, which is essentially formed along the direction of the arrow X, of identical lamps 10′ results, the lamp elements 15′ of the second type in each case being aligned alternately along the direction Y or the direction Y′.

Alternatively, it is possible to arrange two or more identical lamps 10′ in the form of a halo around the vertex S. When selecting the angle for the triangular base 11′ as shown in the exemplary embodiment in FIG. 3, in particular a halo-like arrangement of six identical lamps 10′ results.

In principle, any other shapes for the lamp 10 according to the invention which are not shown may, of course, also be considered.

1. A lamp (10, 10′), comprising at least one base (11, 11′) for connection to a luminaire-side lamp fitting and at least one LED element (12), characterized in that two or more LED elements (12) are provided which are arranged spaced apart from the base and are combined to form one module (13, 13′).

2. The lamp as claimed in claim 1, characterized in that the module (13, 13′) is prefabricated in the form of a separate element which is to be fixed to the base (11, 11′) of the lamp.

3. The lamp as claimed in claim 1, characterized in that two or more LED elements (12) are at least partially combined to form an essentially row-like arrangement, in particular to form a linear arrangement (13, 13′).

4. The lamp as claimed in claim 3, characterized in that the linear arrangement (13, 13′) is aligned essentially along a longitudinal axis (L) of the lamp.

5. The lamp as claimed in claim 1, characterized in that the LED elements (12), in particular individually, are designed such that they can be dimmed and/or switched on or off.

6. The lamp as claimed in claim 1, characterized in that the module (13) is essentially light-permeable.

7. The lamp as claimed in claim 1 one of claims 1, characterized in that the module (13′) is designed to be at least partially essentially reflective or light-scattering.

8. The lamp as claimed in claim 1, characterized in that a bulb element (16, 24) is provided which at least partially envelops the module.

9. The lamp as claimed in claim 8, characterized in that the bulb element (16, 24) is made of plastic.

10. The lamp as claimed in claim 9, characterized in that the plastic contains diffusers.

11. The lamp as claimed in claim 10, characterized in that the bulb element is in the form of a plastic injection-molded part, and the diffusers are admixed to the plastic granulate prior to injection molding.

12. The lamp as claimed in claim 10, characterized in that the bulb element is in the form of a plastic injection-molded part, and the diffusers are part of the plastic granulate.

13. The lamp as claimed in claim 10, characterized in that the diffusers are made of fluorescent material.

14. The lamp as claimed in claim 13, characterized in that the fluorescent material converts UV light components, in particular the emissions in the blue or long-wave UV range (for example Hg lines of the lamp element (15, 15′) of the second type) and/or the long-wave UV radiation emitted by the LED elements (12, 12′), into visible light.

15. The lamp as claimed in claim 8, characterized in that the bulb element (16, 24) is in the form of a diffuser.

16. The lamp as claimed in claim 8, characterized in that at least one lamp element (15, 15′) of the second type is arranged on the base (11, 11′).

17. The lamp as claimed in claim 16, characterized in that the lamp element (15, 15′) of the second type has a fluorescent layer.

18. The lamp as claimed in claim 17, characterized in that the arrangement of the lamp element (15, 15′) of the second type and the module (13, 13′) is selected such that, at a given radiation characteristic for the LED elements (12, 12′), the LED radiation hits, in particular exclusively, the fluorescent layer of the lamp element (15, 15′).

19. The lamp as claimed in claim 17, characterized in that multiple reflections take place between the fluorescent layer and the module (13, 13′).

20. The lamp as claimed in claim 16, characterized in that the lamp element (15, 15′) of the second type is in the form of a compact fluorescent lamp or a high-pressure discharge lamp.

21. The lamp as claimed in claim 16, characterized in that the lamp element (15, 15′) of the second type is designed such that it can be dimmed and/or switched on or off.

22. The lamp as claimed in claim 1, characterized in that a bulb element (16, 24) is provided which at least partially envelops both the module (13, 13′) having the LED elements (12) and the lamp element (15, 15′) of the second type.

23. The lamp as claimed in claim 1, characterized in that the lamp is essentially symmetrical with respect to a central plane (E) of the lamp (10, 10′).

24. The lamp as claimed in claim 1, characterized in that the module (13, 13′) is arranged centrally on the base (11, 11′).

25. The lamp as claimed in claim 1, characterized in that at least two modules (13, 13′) are arranged, in particular spaced apart from one another, symmetrically along a central plane (E) of the lamp.

26. The lamp as claimed in claim 1, characterized in that two sections of a module (13, 13′) are provided, spaced apart from one another, symmetrically with respect to a central plane of the lamp.

27. The lamp as claimed in claim 1, characterized in that the LED elements (12) are each provided on one side of the module (13, 13′).
